(19) United States
(12) Patent Application Publication
(10) Pub. No.: US 2019/0006911 A1
(43) Pub. Date: Jan. 3, 2019

(54) POWER GENERATION DEVICE

(71) Applicant: JHL CO., LTD., Iruma-gun, Saitama (JP)

(72) Inventors: Kiichi TAKEHANA, Iruma-gun, Saitama (JP); Toshiichi TAKEHANA, Iruma-gun, Saitama (JP); Koji TAKEHANA, Iruma-gun, Saitama (JP)

(21) Appl. No.: 16/069,411

(22) PCT Filed: Jan. 20, 2016
(86) PCT No.: PCT/JP2016/052406

§ 371 Date: Jul. 11, 2018

(51) Int. Cl. H02K 7/116; H02K 1/22; H02K 7/00

(52) U.S. Cl. CPC H02K 7/116; B60K 25/00; H02K 7/003; H02K 1/22

(57) ABSTRACT

A power generation device capable of achieving reduction in size and compactification and further increasing a power generation amount is provided. In a power generation device 20 including an input-side gear mechanism 30A that is driven by external motive power, and an output-side gear mechanism 30B to which motive power is transmitted from the input-side gear mechanism 30A, in which a generator 53 is connected to the output-side gear mechanism 30B, the input-side gear mechanism 30A and the output-side gear mechanism 30B are each configured such that an annular internal gear 37 is disposed concentrically with a sun gear 38, and a plurality of intermediate gears are interposed in an annular space between the internal gear 37 and the sun gear 38, between a pair of side plates 31 and 32, a first output shaft 52A is provided in the sun gear 38 of the input-side gear mechanism 30A, the first output shaft 52A is connected to the internal gear 37 of the output-side gear mechanism 30B, a second output shaft 52B is provided in the sun gear 38 of the output-side gear mechanism 30B, and the second output shaft 52B is connected to the generator 53, and the external motive power is input to the internal gear 37 of the input-side gear mechanism 30A.

### TECHNICAL FIELD

The present invention relates to a power generation device.

### BACKGROUND ART

There has been conventionally a power generation device in which a pulley for an axle is provided at an axle of a driven wheel of a vehicle, a pulley for a generator is provided at a rotary shaft of a generator included in the vehicle, a belt is wound on the pulley for the axle and the pulley for the generator, and rotation of the driven wheel is transmitted to the generator to generate electric power (refer to Patent Literature 1, for example).

Further, there is a power generation device in which an input-side gear mechanism is connected to a driven wheel of a vehicle, an output-side gear mechanism is connected to the input-side gear mechanism, and a generator is provided in the output-side gear mechanism (refer to Patent Literature 2, for example).

### CITATION LIST

### Patent Literature

Patent Literature 1: Japanese Utility Model Registration No. 3170663

Patent Literature 2: International Publication No. WO 2015/194058

### SUMMARY OF INVENTION

### Technical Problem

When in Patent Literature 1, an outside diameter ratio of the pulley for the axle and the pulley for the generator is increased to increase a power generation capability of the generator, it is necessary to make an outside diameter of the pulley for the axle larger than the pulley for the generator. However, a space between the axle and a floor panel of a vehicle body is limited, so that increasing the outside diameter of the pulley for the axle is restricted, and it is difficult to increase a transmission ratio. Accordingly, the power generation amount of the generator cannot be increased. Further, a large space between the pulley for the axle and the pulley for the generator is occupied by the belt.

Further, in Patent Literature 2, in order to handle with increasing demand for electric power of the vehicle, it is also desired to increase a power generation amount while making the power generation device small in size and compact.

The present invention is made in the light of the aforementioned circumstances, and an object of the present invention is to provide a power generation device that can achieve reduction in size and compactification, and can further increase a power generation amount.

### Solution to Problem

In order to solve the aforementioned problem, the present invention is a power generation device, wherein at one end portion side of a support member composed of a housing, an input-side gear mechanism that has a pair of side plates one of which is fixed to the support member, and that supports first bearings on respective outer surfaces of the pair of side plates is supported, at the other end portion side of the support member composed of the housing, an output-side gear mechanism that has a pair of side plates one of which is fixed to the support member is supported, the input-side gear mechanism and the output-side gear mechanism are each configured such that an annular internal gear is disposed concentrically with a sun gear and a plurality of intermediate gears are interposed in an annular space between the internal gear and the sun gear, the annular internal gear and the plurality of intermediate gears being between the pair of side plates, the internal gear of the input-side gear mechanism is driven by external motive power, the power generation device includes a first output shaft that extends from both ends of the sun gear of the input-side gear mechanism, and penetrates through the pair of side plates to be rotatably supported by a pair of the first bearings of the input-side gear mechanism, the internal gear of the output-side gear mechanism is driven by motive power transmitted from the first output shaft via a connecting member provided at one end portion of the first output shaft, the power generation device includes a second output shaft that extends from both ends of the sun gear of the output-side gear mechanism, and penetrates through the pair of side plates with one end portion rotatably supported by a second bearing provided at the output-side gear mechanism, a rotor of a generator is fixed to the second output shaft, and a generator configuring member that generates electric power by relatively rotating to the rotor is fixed to a support member side or a connecting member side to surround the rotor, and the connecting member is disposed in the support member with the internal gear of the output-side gear mechanism.

In the above described configuration, in the output-side gear mechanism, the second bearing may be provided at a side plate farther from the rotor, out of the pair of side plates.

Further, in the above described configuration, the generator configuring member of the generator may be provided on an inner circumferential surface of an intermediate support member that connects the other side plate of the output-side gear mechanism and the support member.

Further, in the above described configuration, the connecting member may include a circumferential wall that is attached to an outer circumferential portion of the internal gear of the output-side gear mechanism, and the generator configuring member of the generator may be provided on an inner circumferential surface of the circumferential wall.

Further, in the above described configuration, the second output shaft may have the other end portion of the second output shaft supported by an end portion of the first output shaft or the support member.

Further, in the above described configuration, an outer circumferential portion of the one of the side plates of the input-side gear mechanism may be fixed to one end portion of the support member, and the first bearing may be surrounded by the one end portion of the support member.

### Advantageous Effects of Invention

In the present invention, the first output shaft is provided in the sun gear of the input-side gear mechanism, the first output shaft is connected to the internal gear of the output-side gear mechanism, the second output shaft is provided in the sun gear of the output-side gear mechanism, and the second output shaft is connected to the generator, and the external motive power is input to the internal gear of the input-side gear mechanism, so that it becomes possible to increase the speed of rotation which is input from the external motive power by the input-side gear mechanism and the output-side gear mechanism respectively, the generator can be driven by the rotation the speed of which is increased, and the power generation amount of the generator can be further increased. Further, in both of the input-side gear mechanism and the output-side gear mechanism, the motive power which is transmitted to the sun gears from the internal gears via the plurality of intermediate gears can be shared by the plurality of intermediate gears, and the intermediate gears can be reduced in size.

Accordingly, reduction in size and compactification of the input-side gear mechanism and the output-side gear mechanism can be achieved while the transmitted torque is ensured, and as a result, reduction in size and compactification of the power generation device can be achieved.

Further, the first output shaft is connected to the internal gear of the output side gear mechanism via the connecting member, and the connecting member is spline-coupled to the first output shaft, so that the input-side gear mechanism and the output-side gear mechanism can be easily connected by spline-coupling the first output shaft and the connecting member, and assemblability can be enhanced.

Further, the generator is configured by the inner rotor that is fixed to the second output shaft, and the outer rotor that is fixed to the connecting member so as to surround the inner rotor, and the generator is disposed between the input-side gear mechanism and the output-side gear mechanism, so that by providing the outer rotor at the connecting member which connects the first output shaft and the internal gear of the output-side gear mechanism, a member that supports the outer rotor does not have to be specially provided, the number of components can be decreased, and cost can be suppressed. Further, by disposing the generator between the input-side gear mechanism and the output-side gear mechanism, reduction in size and compactification of the power generation device can be achieved.

Further, in the one end portion of the first output shaft, the male spline which is spline-coupled to the connecting member, and the hollow portion which is provided inside in a radial direction of the male spline are formed, and the one end portion of the second output shaft is fitted to the hollow portion via the bearing for the output shaft, so that the connecting portion of the first output shaft and the second output shaft can be formed to be compact, and reduction in size and compactification of the power generation device can be achieved. Further, by fitting the first output shaft and the second output shaft via the bearing for the output shaft, support rigidity of the first output shaft and the second output shaft can be enhanced, and motive power can be efficiently transmitted.

Further, in the output-side gear mechanism, the bearing support portion is provided at only the side plate farther from the generator, out of the pair of side plates, and the side plate side bearing that supports the second output shaft is attached to the bearing support portion, so that the shape of the side plate closer to the generator can be simplified, and cost can be suppressed.

### BRIEF DESCRIPTION OF THE DRAWINGS

FIG. 1 is a schematic view illustrating a vehicle that is loaded with a power generation device of a first embodiment according to the present invention.

FIG. 2 is a sectional view of the power generation device of the first embodiment which is connected to a rear wheel.

FIG. 3 is an enlarged view of a main part of an input-side gear mechanism illustrated in FIG. 2.

FIG. 4 is an enlarged view of a main part of an output-side gear mechanism illustrated in FIG. 2.

FIG. 5 is a sectional view taken along line V-V in FIG. 2.

FIG. 6 is a sectional view of a power generation device of a second embodiment that is connected to a rear wheel.

### DESCRIPTION OF EMBODIMENTS

Hereinafter, embodiments of the present invention will be described with reference to the drawings.

### First Embodiment

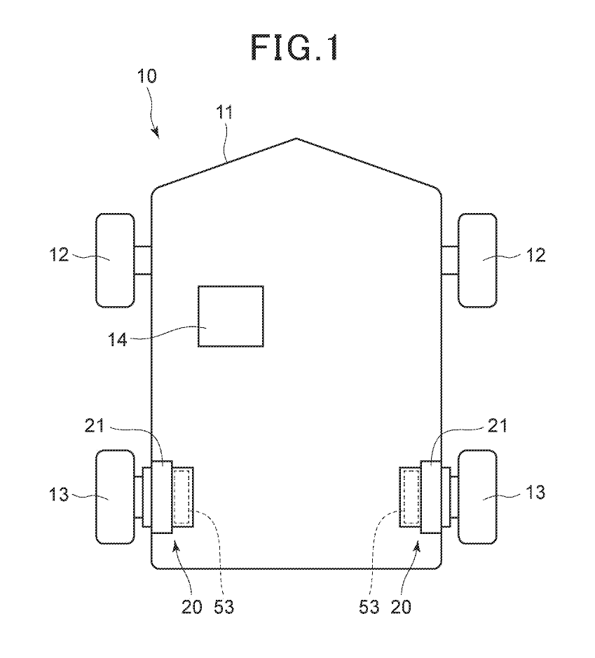

FIG. 1 is a schematic view illustrating a vehicle 10 loaded with a power generation device 20 of a first embodiment according to the present invention.

The vehicle 10 includes a vehicle body 11, a pair of left and right front wheels 12 and 12, a pair of left and right rear wheels 13 and 13, a power unit 14 and a pair of left and right power generation devices 20 and 20.

The front wheels 12 and 12 are driving wheels that are rotatably supported by the vehicle body 11, the front wheels 12 and 12 are connected to a steering device (not illustrated) supported by the vehicle body 11, and are steered to the left and right by a steering wheel operation of a riding driver. The rear wheels 13 and 13 are driven wheels that are rotatably supported by the vehicle body 11. The power unit 14 is a drive source that drives the front wheels 12 and 12, and is composed of an engine or an electric motor, or an engine and an electric motor.

In the case of an engine, a fuel tank that stores fuel of the engine is included, and in the case of an electric motor, a driving battery that drives the electric motor, and a charger that charges the driving battery are included. In both of the cases of the engine and the electric motor, a battery for an auxiliary machine that supplies electric power to auxiliary machine components included in the vehicle may be loaded. The electric power that is generated in the power generation devices 20 and 20 is stored in the driving battery and the battery for an auxiliary machine.

The power unit 14 is connected to the front wheels 12 and 12 directly or via a clutch and a transmission. The rear wheels 13 and 13 are rotatably supported by the vehicle body 11 via parts of the power generation devices 20 and 20 that will be described in detail later.

When the front wheels 12 and 12 are rotationally driven by the power unit 14, the rear wheels 13 and 13 also rotate, and the vehicle 10 travels. The power generation device 20 of the present embodiment generates electric power with rotational forces of the rear wheels 13 and 13 as motive power.

As described above, by connecting the power generation devices 20 respectively to the left and right rear wheels 13 and 13, it becomes possible to equalize a weight balance between the left and right of the vehicle 10, and equalize resistance at a time of the rear wheels 13 rotating on the left and right.

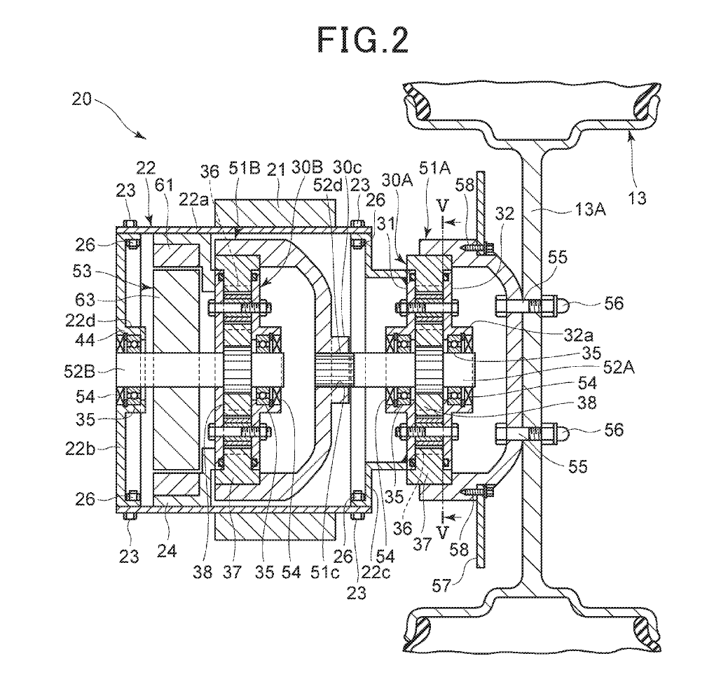

FIG. 2 is a sectional view of the power generation device 20 of the first embodiment which is connected to the rear wheel 13.

The power generation device 20 includes a fixing member 21, a housing 22, an input-side gear mechanism 30A, an input-side cup-shaped joint 51A, a first output shaft 52A, an output-side cup-shaped joint 51B, an output-side gear mechanism 30B, a second output shaft 52B and a generator 53.

The fixing member 21 is fixed to the vehicle body 11 (refer to FIG. 1), or configures a part of the vehicle body 11. The housing 22 is a member that is attached to the fixing member 21. The housing 22 is composed of a housing main body 22a that is attached to the fixing member 21, and an inner cover 22b and an outer cover 22c that are detachably attached to both end portions of the housing main body 22a respectively with a plurality of bolts 23 and nuts 26. The housing main body 22a is a member in a cylindrical shape or a rectangular box shape which is attached to the fixing member 21. The inner cover 22b is provided at an inner side end portion in a vehicle width direction of the housing main body 22a, and in a cylindrical portion 22d that is formed in a central portion of the inner cover 22b, a ball bearing 35 and an oil seal 54 are provided. The ball bearing 35 is prevented from removing from the cylindrical portion 22d by a retaining ring 44 that is fitted in an annular groove formed in an inner circumferential surface of the cylindrical portion 22d. The outer cover 22c is provided at an outer side end portion in the vehicle width direction of the housing main body 22a, and the input-side gear mechanism 30A (in more detail, a side plate 31 that will be described in detail later) is fixed to an outer side end portion in the vehicle width direction of the outer cover 22c. In the housing main body 22a or the inner cover 22b, a conductor wire insertion hole (not illustrated) for passing a conductor wire (not illustrated) that takes out generated electric power to an outside from the generator 53 is opened.

The input-side gear mechanism 30A is a transmission mechanism that is attached to one end portion of the housing 22, includes a plurality of gears, and increases a speed of output relative to input, and by a configuration of the input-side gear mechanism 30A, reduction in size and weight and compactification of the input-side gear mechanism 30A are achieved. An outer circumferential portion of the input-side cup-shaped joint 51A is attached to an outer circumferential portion (in more detail, an internal gear 37 that will be described in detail later) of the input-side gear mechanism 30A. The input-side cup-shaped joint 51A is formed into a cup shape in which a center of the input-side cup-shaped joint 51A is recessed, and a wheel 13A that configures the rear wheel 13 is attached to a bottom portion of the cup with a plurality of bolts 55 and nuts 56. Note that reference sign 57 denotes a brake disk that is attached to the outer circumferential portion of the input-side cup-shaped joint 51A with a plurality of bolts 58. The brake disk 57 configures a disk brake with a brake caliper not illustrated, and the brake disk 57 is braked by the brake caliper.

As a material of the input-side cup-shaped joint 51A, in order to make a vehicle weight and inertial moment smaller, a light metal such as an aluminum, magnesium, titanium or alloys of these metals is preferable. As illustrated, the input-side gear mechanism 30A and the input-side cup-shaped joint 51A are formed to be small in size so as to be inside the wheel 13A of the rear wheel 13 and within a width of the rear wheel 13. The first output shaft 52A is a member corresponding to an axle of the rear wheel 13, penetrates through a central portion of the input-side gear mechanism 30A to extend in the vehicle width direction, and is rotatably supported by the input-side gear mechanism 30A via a pair of ball bearings 35 and 35. A male spline 52d is formed at one end portion of the first output shaft 52A.

The output-side cup-shaped joint 51B is formed into a cup shape in which a center is recessed, an outer circumferential portion of the cup is attached to an outer circumferential portion of the output-side gear mechanism 30B, and a female spline 51c is formed in a boss portion 30c that is provided at a bottom portion of the cup. The male spline 52d of the first output shaft 52A is spline-coupled to the female spline 51c. The output-side gear mechanism 30B is a transmission mechanism that is attached to the housing main body 22a via a gear mechanism support member 24 that is provided in the housing 22, includes a plurality of gears, and increases a speed of output with respect to input. By the configuration, reduction in size and weight and compactification of the output-side gear mechanism 30B are achieved.

The second output shaft 52B penetrates through a central portion of the output-side gear mechanism 30B to extend in the vehicle width direction, and is rotatably supported by the output-side gear mechanism 30B and the inner cover 22b respectively via the ball bearings 35. The generator 53 is provided close to the output-side gear mechanism 30B, and includes a cylindrical stator 61 attached to an inner circumferential portion of the gear mechanism support member 24, and a rotor 63 that is attached to the second output shaft 52B and is disposed inside of the stator 61. The generator 53 generates electric power by the rotor 63 rotating in the stator 61.

As described above, the stator 61 is supported by the gear mechanism support member 24 for fixing the output-side gear mechanism 30B to the housing main body 22a, and thereby a special member that supports the stator 61 becomes unnecessary, so that the number of components can be decreased, and cost can be suppressed. Further, the stator 61 is attached to an inner circumferential surface of the gear mechanism support member 24, so that a protruding amount of the generator 53 to the inner side in the vehicle width direction can be suppressed, and reduction in size and compactification of the power generation device 20 can be achieved.

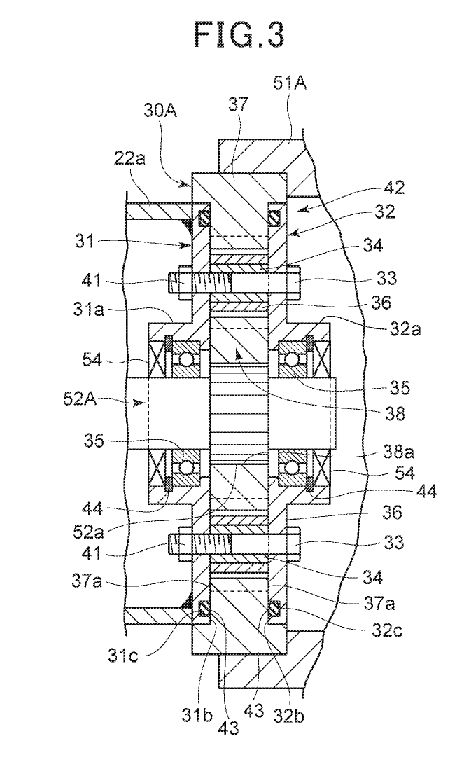

FIG. 3 is an enlarged view of a main part of the input-side gear mechanism 30A illustrated in FIG. 2.

The input-side gear mechanism 30A includes side plates 31 and 32, a collar 34, an intermediate gear 36, the internal gear 37 and a sun gear 38.

The side plate 31 is attached to an end portion of the housing main body 22a by welding. The side plate 32 is disposed apart so as to face the side plate 31. The side plates 31 and 32 are disks of a same shape, and the first output shaft 52A penetrates through the side plates 31 and 32. In more detail, the side plates 31 and 32 integrally include cylindrical portions 31a and 32a that protrude in an axial direction of the first output shaft 52A respectively. In the cylindrical portions 31a and 32a, the ball bearings 35, the retaining rings 44 that prevent the ball bearings 35 from removing, and the oil seals 54 which are provided at open end sides of the cylindrical portions 31a and 32a are disposed in the respective inner sides. The collar 34 is cylindrical, and in a state where the collar 34 is sandwiched by the side plates 31 and 32, the bolt 33 penetrates through the side plates 31 and 32 and the collar 34, and a nut 41 is screwed to a tip end portion of the bolt 33.

The intermediate gears 36 are rotatably supported by a plurality of collars 34 respectively. A plurality of intermediate gears 36 are provided, so that it becomes possible to transmit torque to the sun gear 38 from the internal gear 37 by sharing the torque by the plurality of intermediate gears 36. The internal gear 37 is an annular member that is disposed outside of the plurality of intermediate gears 36 so as to be meshed with the plurality of intermediate gears 36. An outer circumferential portion of the input-side cup-shaped joint 51A is fitted and is attached by welding to an outer circumferential portion of the internal gear 37. The outer circumferential portion of the internal gear 37 is located outward in a radial direction from outer circumferential edges of the side plates 31 and 32, and an outside diameter of the internal gear 37 is larger than outside diameters of the side plates 31 and 32. Thereby, the cup-shaped joint 51 can be easily attached to the outer circumferential portion of the internal gear 37. The sun gear 38 is meshed with the plurality of intermediate gears 36 and is spline-coupled to the first output shaft 52A.

A ratio of the numbers of teeth of the internal gear 37 and the sun gear 38 is 2:1, for example, when the internal gear 37 rotates, rotation of the internal gear 37 is transmitted to the sun gear 38 via the plurality of intermediate gears 36, and a rotation angle of the sun gear 38 becomes twice as large as a rotation angle of the internal gear 37.

In the input-side gear mechanism 30A, in the state where the plurality of collars 34 are disposed between the pair of side plates 31 and 32, the side plates 31 and 32 are fastened by the bolts 33 which penetrate through the side plates 31 and 32 and the plurality of collars 34, and the nuts 41 that are screwed to the bolts 33. As a result, a distance between the side plates 31 and 32 is kept constant, a clearance between the intermediate gear 36 and the side plates 31 and 32 is constant, and rotation of the intermediate gear 36 can be stabilized. The collar 34 has both a function of keeping the distance between the side plates 31 and 32 described above constant, and a function of rotatably supporting the intermediate gear 36, so that the number of components can be reduced, and cost can be suppressed.

The pair of side plates 31 and 32 configures a gear box 42 that houses the plurality of intermediate gears 36, the internal gear 37 and the sun gear 38. A lubricating oil is sealed in the gear box 42.

The internal gear 37 has side surfaces 37a and 37a of the internal gear 37 supported slidably by the pair of side plates 31 and 32, or disposed via a very small clearance. Annular O-ring grooves 31c and 32c are formed on an outer circumferential sides of the inner side surfaces 31b and 32b of the side plates 31 and 32, O-rings 43 are respectively disposed in the O-ring grooves 31c and 32c, and spaces between the side plates 31 and 32, and the internal gear 37 are sealed. By providing the O-rings 43 in this way, dust, mud, rainwater and the like can be prevented from entering the gear box 42.

Accordingly, wear of a portion that supports rotation of the gears in the gear box 42 and a meshing portion of the gears is restrained, and leakage of the lubricating oil can be also prevented.

In the first output shaft 52A, a male spline 52a is integrally formed in an intermediate portion, and the male spline 52a is spline-coupled to a female spline 38a that is formed in the sun gear 38, and motive power is transmitted to the first output shaft 52A from the sun gear 38.

As described above, by forming the pair of side plates 31 and 32 in the same shape, a kind of side plates 31 and 32 does not have to be increased, component management can be easily performed, and cost can be suppressed.

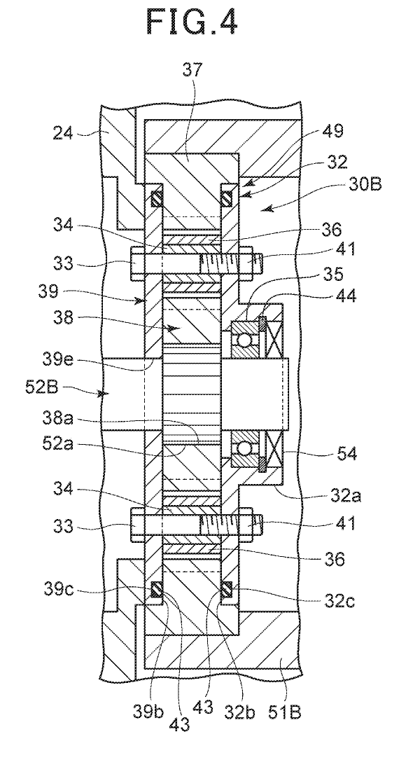

FIG. 4 is an enlarged view of a main part of the output-side gear mechanism 30B illustrated in FIG. 2.

In the output-side gear mechanism 30B, only a side plate 39 differs from the side plate 31 of the input-side gear mechanism 30A (refer to FIG. 3).

The side plate 39 is a flat plate in a circular shape which is attached to the gear mechanism support member 24, and a penetration hole 39e through which the second output shaft 52B penetrates is opened in a central portion of the circular shape. In a state where a plurality of collars 34 are disposed between the pair of side plates 39 and 32, the side plates 39 and 32 are fastened by the bolts 33 that penetrate through the side plates 39 and 32 and the plurality of collars 34, and the nuts 41 which are screwed to the bolts 33. The pair of side plates 39 and 32 has outside diameters formed to be the same.

The pair of side plates 39 and 32 configures a gear box 49 that houses the plurality of intermediate gears 36, the internal gear 37 and the sun gear 38. A lubricating oil is sealed in the gear box 49.

An annular O-ring groove 39c is formed on an outer circumferential side of an inner side surface 39b of the side plate 39, an O-ring 43 is disposed in the O-ring groove 39c, and a space between the side plate 39 and the internal gear 37 is sealed.

The internal gear 37 has an outer circumferential portion of the internal gear 37 attached to the outer circumferential portion of the output-side cup-shaped joint 51B.

The second output shaft 52B has a male spline 52a formed on an intermediate portion of the second output shaft 52B, and the male spline 52a is disposed between the pair of side plates 39 and 32. The male spline 52a and a female spline 38a which is formed in the sun gear 38 are spline-coupled.

In the above described pair of side plates 39 and 32, the ball bearing 35 is provided in only the side plate 32 which is farther from the generator 53. In this way, the second output shaft 52B is supported by the ball bearings 35 which are provided in the side plate 32 which is farther from the generator 53 out of the pair of side plates 39 and 32 and the inner cover 22b respectively, whereby both end portions of the second output shaft 52B can be supported. Thereby, a distance where the second output shaft 52B is supported becomes maximum, and support rigidity of the second output shaft 52B can be enhanced.

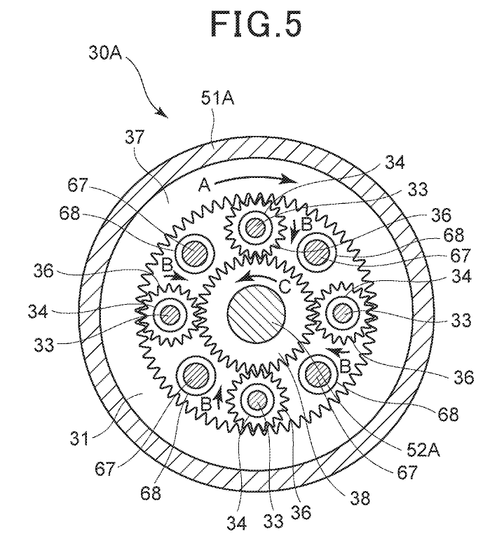

FIG. 5 is a sectional view taken along line V-V in FIG. 2.

Note that FIG. 5 is also a sectional view of the output-side gear mechanism 30B (In this case, reference sign 30A illustrated in FIG. 5 is replaced with 30B, reference sign 51A is replaced with 51B, and reference sign 52A is replaced with 52B.), and a structure and an operation will be described with respect to the input-side gear mechanism 30A on behalf of the output-side gear mechanism 30B.

In an annular space between the internal gear 37 and the sun gear 38, the plurality of bolts 67 and the cylindrical collars 68 that are fitted onto the respective bolts 67 are disposed, in addition to the plurality of intermediate gears 36.

The bolt 67 has a nut (not illustrated) screwed to a tip end portion that penetrates through the collar 68 and the side plates 31 and 32. The collar 68 is disposed between the pair of side plates 31 and 32 (refer to FIG. 3 for the side plate 32) similarly to the collar 34.

An outside diameter of a shaft portion of the bolt 67 may be the same as or different from an outside diameter of a shaft portion of the bolt 33. An entire length of the collar 68 is the same as an entire length of the collar 34. An inside diameter and an outside diameter of the collar 68 may be the same as or different from an inside diameter and an outside diameter of the collar 34.

By providing the plurality of bolts 67 and nuts and the plurality of collars 68 in this way, the pair of side plates 31 and 32 can be fastened more firmly as compared with the pair of side plates 31 and 32 being fastened with a plurality of bolts 33 and nuts 41 (refer to FIG. 3) and the collars 34. Further, by disposing the respective bolts 67 and nuts and the respective collars 68 between the adjacent intermediate gears 36 and 36 in the annular space, a dead space can be effectively used, and compactification of the input-side gear mechanism 30A can be achieved.

As illustrated by an arrow A, when the internal gear 37 rotates, the respective intermediate gears 36 rotate as illustrated by arrows B, and the sun gear 38 and the first output shaft 52A (or the second output shaft 52B (refer to FIG. 4)) integrally rotate as illustrated by an arrow C. At this time, the sun gear 38 rotates in an opposite direction with respect to the internal gear 37, and a rotation angle of the sun gear 38 becomes twice as large as a rotation angle of the internal gear 37.

For example, when the internal gear 37 rotates by 360° (one rotation), the sun gear 38 rotates by 720° (two rotations). As a relative rotation, with respect to the rotation angle of 360° of the internal gear 37, the sun gear 38 rotates by 360+720=1080°. In other words, while the internal gear 37 makes one rotation, the sun gear 38 makes three rotations with respect to the internal gear 37.

Returning to FIG. 2, when the rear wheel 13 makes one rotation, the first output shaft 52A makes two rotations. When the first output shaft 52A makes two rotation, the second output shaft 52B makes four rotations, and the rotor 63 makes four rotations.

An example is shown, in which a ratio of the numbers of teeth of the internal gear 37 and the sun gear 38 is made 2:1 in the input-side gear mechanism 30A and the output-side gear mechanism 30B, but the ratio of the numbers of teeth may be properly changed in accordance with specifications of the generator 53, a use situation of the driving battery, a use environment of the vehicle 10 (refer to FIG. 1) and the like without being limited to this.

In FIG. 5, torque that is transmitted to the sun gear 38 from the internal gear 37 is dispersed to the plurality (four) of intermediate gears 36, so that torque that is transmitted by the single intermediate gear 36 can be decreased more, and the intermediate gear 36 can be made small in size by decreasing the outside diameter and a width. When the intermediate gear 36 becomes small in size, a distance between the internal gear 37 and the sun gear 38 can be reduced, and a diameter of the internal gear 37 can be made small. As a result, reduction in size, compactification and reduction in weight of the input-side gear mechanism 30A (and the output-side gear mechanism 30B (refer to FIG. 2)) can be achieved. Note that the number of intermediate gears 36 is not limited to the above described number, but may be plural number.

As illustrated in FIG. 2 to FIG. 4 as above, in the power generation device 20 including the input-side gear mechanism 30A which is driven by external motive power (the rear wheels 13 and 13 of the vehicle 10 illustrated in FIG. 1), and the output-side gear mechanism 30B to which motive power is transmitted from the input-side gear mechanism 30A, in which the generator 53 is connected to the output-side gear mechanism 30B, the input-side gear mechanism 30A and the output-side gear mechanism 30B are configured such that the annular internal gears 37 are disposed concentrically with the sun gears 38, and the plurality of intermediate gears 36 are interposed in the annular spaces between the internal gears 37 and the sun gears 38, respectively between the pair of side plates 31 and 32, and the pair of side plates 39 and 32, and the side plates 31 and 39 at one sides are fixed to the housing 22 as the support member, the first output shaft 52A is provided in the sun gear 38 of the input-side gear mechanism 30A, the first output shaft 52A is connected to the internal gear 37 of the output-side gear mechanism 30B, the second output shaft 52B is provided in the sun gear 38 of the output-side gear mechanism 30B, the second output shaft 52B is connected to the generator 53, and the external motive power is input to the internal gear 37 of the input-side gear mechanism 30A.

According to the configuration, it becomes possible to increase the speed of rotation which is input from the external motive power by the input-side gear mechanism 30A and the output-side gear mechanism 30B, the generator 53 can be driven by the rotation the speed of which is increased, and the power generation amount of the generator 53 can be further increased. Further, in both of the input-side gear mechanism 30A and the output-side gear mechanism 30B, the motive power which is transmitted to the sun gears 38 from the internal gears 37 via the plurality of intermediate gears 36 can be shared by the plurality of intermediate gears 36, and the intermediate gears 36 can be reduced in size. Accordingly, reduction in size and compactification of the input-side gear mechanism 30A and the output-side gear mechanism 30B can be achieved while the transmitted torque is ensured, and reduction in size and as a result, compactification of the power generation device 20 can be achieved.

Further, as illustrated in FIG. 2, the first output shaft 52A is connected to the internal gear 37 of the output-side gear mechanism 30B via the output-side cup-shaped joint 51B as the connecting member, and the output-side cup-shaped joint 51B is spline-coupled to the first output shaft 52A. By spline-coupling the first output shaft 52A and the output-side cup-shaped joint 51B, the input-side gear mechanism 30A and the output-side gear mechanism 30B can be easily connected, and assemblability can be enhanced.

Further, as illustrated in FIG. 2 and FIG. 4, in the output-side gear mechanism 30B, the cylindrical portion 32a as the bearing support portion is provided at only the side plate 32 which is farther from the generator 53, out of the pair of side plates 39 and 32, and the ball bearing 35 as the side plate side bearing that supports the second output shaft 52B is attached to the cylindrical portion 32a. Thereby, the shape of the side plate 39 which is closer to the generator 53 can be simplified, and cost of the power generation device 20 can be suppressed.

### Second Embodiment

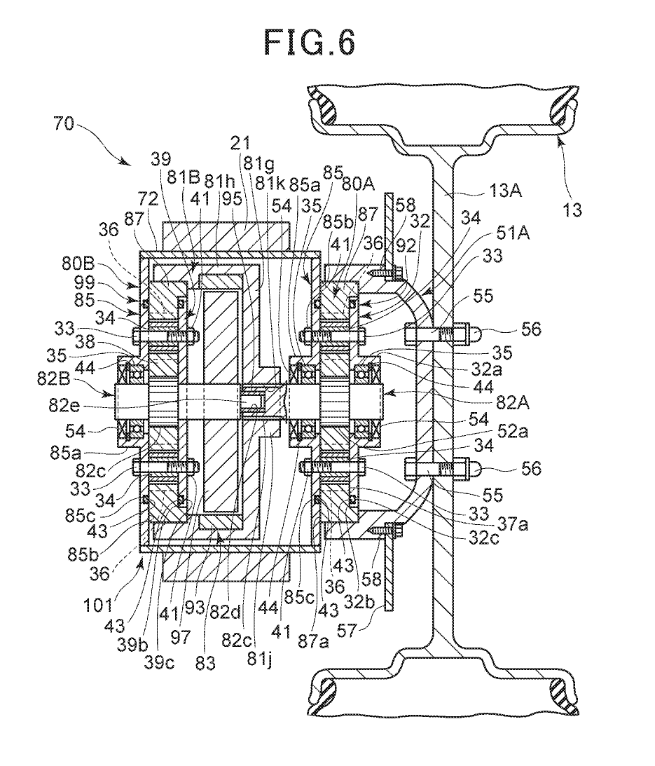

FIG. 6 is a sectional view of a power generation device 70 of a second embodiment that is connected to the rear wheel 13.

The same components as in the first embodiment illustrated in FIG. 2 are assigned with the same reference signs, and detailed explanation will be omitted.

The power generation device 70 includes the fixing member 21, a housing main body (support member) 72, an input-side gear mechanism 80A, the input-side cup-shaped joint 51A, a first output shaft 82A, an output-side cup-shaped joint (connecting member) 81B, an output-side gear mechanism 80B, a second output shaft 82B and a generator 83.

The housing main body 72 is a member in a cylindrical shape or a rectangular box shape that is attached to the fixing member 21, both end portions of the housing main body 72 are attached to the input-side gear mechanism 80A and the output-side gear mechanism 80B.

In the input-side gear mechanism 80A, a side plate 85 and an internal gear 87 illustrated in FIG. 6 are different from the side plate 31 and the internal gear 37 of the input-side gear mechanism 30A illustrated in FIG. 2.

The side plate 85 forms a disk shape in which an outside diameter is made large with respect to the side plate 31, and an outer circumferential portion of the side plate 85 is fixed to the housing main body 72.

The pair of side plates 85 and 32 configures a gear box 92 that houses a plurality of intermediate gears 36, the internal gear 87 and the sun gear 38. A lubricating oil is sealed in the gear box 92.

The internal gear 87 has one side surface 87a flattened as the outside diameter of the side plate 85 is made large, and the input-side cup-shaped joint 51A is attached to an outer circumferential portion of the internal gear 87. The other side surface 37a of the internal gear 87 is not changed with respect to the internal gear 37.

The internal gear 87 has side surfaces 87a and 37a of the internal gear 87 slidably supported by the pair of side plates 85 and 32, or disposed via a very small clearance. Annular O-ring grooves 85c and 32c are formed on outer circumferential sides of inner side surfaces 85b and 32b of the side plates 85 and 32, the O-rings 43 are respectively disposed in the O-ring grooves 85c and 32c, and spaces between the side plates 85 and 32, and the internal gear 87 are sealed.

The first output shaft 82A is rotatably supported by the pair of ball bearings 35 and 35 which are provided in cylindrical portions (bearing support portions) 85a and 32a of the side plates 85 and 32, and the male spline 52a is formed inside from the side plates 85 and 32 of the first output shaft 82A. In an end portion at a generator 83 side, of the first output shaft 82A, a male spline 82c and a hollow portion 82d provided inside in a radial direction of the male spline 82c are formed.

The output-side cup-shaped joint 81B is made of a light metal similarly to the input-side cup-shaped joint 51A, and is formed integrally of a disk portion 81g, and a circumferential wall 81h provided at an outer circumferential portion of the disk portion 81g. The disk portion 81g has a boss portion 81j formed in a central portion, and a female spline 81k is formed in the boss portion 81j. The male spline 82c of the first output shaft 82A is spline-coupled to the female spline 81k. The circumferential wall 81h has an end portion of the circumferential wall 81h attached to an outer circumferential portion of an internal gear 87 of the output-side gear mechanism 80B, and an outer rotor 93 that configures the generator 83 is provided at a disk portion 81g side of the circumferential wall 81h.

In the output-side gear mechanism 80B, a side plate 39 is different from the side plate 32 of the input-side gear mechanism 80A.

The side plate 85 has an outer circumferential portion of the side plate 85 fixed to the housing main body 72.

The pair of side plates 85 and 39 configures a gear box 99 that houses a plurality of intermediate gears 36, the internal gear 87 and the sun gear 38. A lubricating oil is sealed in the gear box 99.

The internal gear 87 has the side surfaces 87a and 37a slidably supported by the pair of side plates 85 and 39, or disposed via a very small clearance. The annular O-ring grooves 85c and 39c are formed on outer circumferential sides of inner side surfaces 85b and 39b of the side plates 85 and 39, the O-rings 43 are respectively disposed in the O-ring grooves 85c and 39c, and spaces between the side plates 85 and 39, and the internal gear 87 are sealed.

One end portion of the second output shaft 82B is rotatably supported by the ball bearing 35 which is provided inside of a cylindrical portion 85a of the side plate 85, and the other end portion is rotatably supported by a needle bearing (bearing for an output shaft) 95 that is provided in the hollow portion 82d of the first output shaft 82A. A male spline 82c is provided inside from the side plates 85 and 39 of the second output shaft 82B, and in the other end portion of the second output shaft 82B, a small diameter portion 82e that is supported by the needle bearing 95 is formed. An occupancy space of a connecting portion of the first output shaft 82A and the output-side cup-shaped joint 81B and a connecting portion of the first output shaft 82A and the second output shaft 82B can be made smaller. Note that a small ball bearing may be used in place of the needle bearing 95. The generator 83 is configured by an inner rotor 97 that is fixed to an outer side in the vehicle width direction from the output-side gear mechanism 80B, of the second output shaft 82B, and the outer rotor 93 which is fixed to an inner circumferential surface of the circumferential wall 81h of the output-side cup-shaped joint 81B to surround the inner rotor 97.

In the input-side gear mechanism 80A, the first output shaft 82A is supported by the ball bearings 35 and 35 which are provided at both the side plates 85 and 32, and the output-side gear mechanism 80B is supported by the bearing 35 which is provided at the side plate 85 at one side and the needle bearing 95 which is provided in the first output shaft 82A. Thereby, support rigidity of the first output shaft 82A and the second output shaft 82B is enhanced, rotation of the inner rotor 97 which is attached to the second output shaft 82B can be stabilized, and generation of vibration can be suppressed. Further, by using the needle bearing 95, the connecting portion (the power transmission portion) of the first output shaft 82A and the output-side cup-shaped joint 81B can be formed to be more compact, and reduction in size and compactification of the power generation device 70 can be achieved. Further, the side plates 85 are made the same in the input-side gear mechanism 80A and the output-side gear mechanism 80B, whereby kinds of components can be decreased, component management is facilitated, and a number of management steps can be decreased.

The generator 83 is disposed inside of the output-side cup-shaped joint 81B. That is, the generator 83 is disposed between the input-side gear mechanism 80A and the output-side gear mechanism 80B.

A flow of motive power of the power generation device 70 is such that the rear wheel 13→the input-side cup-shaped joint 51A→the input-side gear mechanism 80A→the first output shaft 82A→the output-side cup-shaped joint 81B→the output-side gear mechanism 80B→the second output shaft 82B→the generator 83. In the flow of the motive power, the flow from the rear wheel 13 to the output-side gear mechanism 80B is a flow going to an inside in the vehicle width direction from an outside in the vehicle width direction, and the flow from the second output shaft 82B to the generator 83 is a flow going from the inside in the vehicle width direction to the outside in the vehicle width direction.

By adopting the configuration like this, an entire length of the power generation device 70 can be shortened in an axial direction of the first output shaft 82A and the second output shaft 82B. That is, reduction in size and compactification of the power generation device 70 can be achieved. Further, the outer rotor 93 of the generator 83 is disposed in the output-side cup-shaped joint 81B which is a member that transmits motive power, whereby a member which specially supports the outer rotor 93 becomes unnecessary, the number of components can be reduced, and cost can be reduced. Further, the side plates 85 and 85 of the input-side gear mechanism 80A and the output-side gear mechanism 80B and the housing main body 72 form a housing 101 that is hermetically sealed. The housing 101 uses the components of the input-side gear mechanism 80A and the output-side gear mechanism 80B as components of the housing 101, so that a new component that forms the housing 101 is only the housing main body 72, and cost can be reduced.

In the pair of side plates 85 and 39 of the output-side gear mechanism 80B described above, the ball bearing 35 is provided in only the side plate 85 which is farther from the generator 83. In this way, both the end portions of the second output shaft 82B can be supported by the ball bearing 35 which is provided in the side plate 85 which is farther from the generator 83 out of the pair of side plates 85 and 39, and the needle bearing 95 which is provided between the first output shaft 82A and the second output shaft 82B. Thereby, a distance where the second output shaft 82B is supported becomes maximum, and support rigidity of the second output shaft 82B can be enhanced.

As illustrated in FIG. 6 in the above, the generator 83 is configured by the inner rotor 97 which is fixed to the second output shaft 82B, and the outer rotor 93 which is fixed to the output-side cup-shaped joint 81B as the connecting member so as to surround the inner rotor 97, and the generator 83 is disposed between the input-side gear mechanism 80A and the output-side gear mechanism 80B. By providing the outer rotor 93 at the output-side cup-shaped joint 81B which connects the first output shaft 82A and the internal gear 87 of the output-side gear mechanism 80B, a member that supports the outer rotor 93 does not have to be specially provided, and the number of components can be decreased, and cost can be suppressed. Further, by disposing the generator 83 between the input-side gear mechanism 80A and the output-side gear mechanism 80B, reduction in size and compactification of the power generation device 70 can be achieved.

Further, in one end portion of the first output shaft 82A, the male spline 82c which is spline-coupled to the output-side cup-shaped joint 81B, and the hollow portion 82d which is provided inside in the radial direction of the male spline 82c are formed, one end portion of the second output shaft 82B is fitted to the hollow portion 82d via the needle bearing 95 as the bearing for an output shaft. Thereby, the connecting portion of the first output shaft 82A and the second output shaft 82B can be formed to be compact, and reduction in size and compactification of the power generation device 70 can be achieved. Further, the first output shaft 82A and the second output shaft 82B are fitted via the needle bearing 95, whereby the support rigidity of the first output shaft 82A and the second output shaft 82B can be enhanced, and motive power can be efficiently transmitted.

Further, in the output-side gear mechanism 80B, the cylindrical portion 85a is provided at only the side plate 85 which is farther from the generator 83, out of the pair of side plates 85 and 39, and the ball bearing 35 which supports the second output shaft 82B is attached to the cylindrical portion 85a. Thereby, the shape of the side plate 39 which is closer to the generator 83 can be simplified, and cost of the power generation device 70 can be suppressed.

The aforementioned embodiments only illustrate aspects of the present invention, and the present invention can be modified and applied arbitrarily within the range without departing from the gist of the present invention.

For example, in the above described embodiments, the power generation device 20 illustrated in FIG. 2, and the power generation device 70 illustrated in FIG. 6 each use the rotational force of the rear wheel 13 as the external motive power. As the external motive force, motive power of an engine, a waterwheel, a windmill or a steam turbine, rotational forces of various rotary shafts or the like may be used without being limited to the above.

Further, as illustrated in FIG. 2, in the power generation device 20, an assembly of the input-side cup-shaped joint 51A, the input-side gear mechanism 30A and the first output shaft 52A, and an assembly of the output-side cup-shaped joint 51B, the output-side gear mechanism 30B and the second output shaft 52B are connected in series. In order to further increase the speed, one or a plurality of assemblies each of a cup-shaped joint, a gear mechanism and an output shaft may be connected in series, at a downstream side of the motive power of the second output shaft 52B. The generator is connected to the assembly at a most downstream side of the motive power.

Further, the first output shaft 52A, the second output shaft 52B, the first output shaft 82A and the second output shaft 82B illustrated in FIG. 2 and FIG. 6 are supported by the ball bearings 35, but may be supported by other kinds of bearings without being limited to the ball bearings 35.

In the power generation device 20 illustrated in FIG. 2, the internal gear 37 of the input-side gear mechanism 30A is connected to the input-side cup-shaped joint 51A, whereas in the power generation device 70 illustrated in FIG. 6, the internal gear 87 of the input-side gear mechanism 80A is connected to the input-side cup-shaped joint 51A, but the present invention is not limited to this, and clutches capable of transmitting or cutting off motive power may be provided between the input-side cup-shaped joint 51A and the internal gear 37 of the input-side gear mechanism 30A, and between the input-side cup-shaped joint 51A and the internal gear 87 of the input-side gear mechanism 80A. As the clutch, any type of clutch may be used. For example, a centrifugal clutch is connected when a rotational speed reaches a predetermined rotational speed, and motive power is transmitted. In an electromagnetic clutch, it is possible to transmit or cut off motive power manually or automatically.

Further, the pair of side plates 31 and 32 may be fastened with only the plurality of bolts 33 and nuts 41 (refer to FIG. 3) and the plurality of collars 34, without providing the plurality of bolts 67 and nuts and the plurality of collars 68 illustrated in FIG. 5.

### REFERENCE SIGNS LIST

20, 70 Power generation device
22 Housing (support member)
30A, 80A Input-side gear mechanism
30B, 80B Output-side gear mechanism
31, 32, 39, 85 Side plate
32a, 85a Cylindrical portion (bearing support portion)
35 Ball bearing (bearing for gear mechanism)
36 Intermediate gear
37, 87 Internal gear
38 Sun gear
51B, 81B Output side cup-shaped joint (connecting member)
52A, 82A First output shaft
52B, 82B Second output shaft
53, 83 Generator
72 Housing main body (support member)
82c Male spline
82d Hollow portion
93 Outer rotor
95 Needle bearing (bearing for output shaft)
97 Inner rotor

1-5. (canceled)

6. A power generation device,
wherein at one end portion side of a support member comprising a housing, an input-side gear mechanism that has a pair of side plates one of which is fixed to the support member, and that supports first bearings on respective outer surfaces of the pair of side plates is supported,
at the other end portion side of the support member comprising the housing, an output-side gear mechanism that has a pair of side plates one of which is fixed to the support member is supported,
the input-side gear mechanism and the output-side gear mechanism are each configured such that an annular internal gear is disposed concentrically with a sun gear and a plurality of intermediate gears are interposed in an annular space between the internal gear and the sun gear, the annular internal gear and the plurality of intermediate gears being between the pair of side plates,
the internal gear of the input-side gear mechanism is driven by external motive power,
the power generation device comprises a first output shaft that extends from both ends of the sun gear of the input-side gear mechanism, and penetrates through the pair of side plates to be rotatably supported by a pair of the first bearings of the input-side gear mechanism,
the internal gear of the output-side gear mechanism is driven by motive power transmitted from the first output shaft via a connecting member provided at one end portion of the first output shaft,
the power generation device comprises a second output shaft that extends from both ends of the sun gear of the output-side gear mechanism, and penetrates through the pair of side plates with one end portion rotatably supported by a second bearing provided at the output-side gear mechanism,
a rotor of a generator is fixed to the second output shaft, and a generator configuring member that generates electric power by relatively rotating to the rotor is fixed to a support member side or a connecting member side to surround the rotor, and
the connecting member is disposed in the support member with the internal gear of the output-side gear mechanism.

7. The power generation device according to claim 6,
wherein in the output-side gear mechanism, the second bearing is provided at a side plate farther from the rotor, out of the pair of side plates.

8. The power generation device according to claim 6,
wherein the generator configuring member of the generator is provided on an inner circumferential surface of an intermediate support member that connects the other side plate of the output-side gear mechanism and the support member.

9. The power generation device according to claim 6,
wherein the connecting member includes a circumferential wall that is attached to an outer circumferential portion of the internal gear of the output-side gear mechanism, and the generator configuring member of the generator is provided on an inner circumferential surface of the circumferential wall.

10. The power generation device according to claim 6,
wherein the second output shaft has the other end portion of the second output shaft supported by an end portion of the first output shaft or the support member.

11. The power generation device according to claim 6,
wherein an outer circumferential portion of the one of the side plates of the input-side gear mechanism is fixed to one end portion of the support member, and the first bearing is surrounded by the one end portion of the support member.
